(19) United States
(12) Patent Application Publication
(10) Pub. No.: US 2024/0112025 A1
(43) Pub. Date: Apr. 4, 2024

(54) METHOD FOR SPIKING NEURAL NETWORK COMPUTATION LEARNING BASED TEMPORAL CODING AND SYSTEM THEREOF

(71) Applicant: KOREA UNIVERSITY RESEARCH ANDBUSINESS FOUNDATION, Seoul (KR)

(72) Inventors: Jongsun PARK, Seoul (KR); Dongwoo LEW, Seoul (KR); Kyung Chul LEE, Seoul (KR)

(73) Assignee: KOREA UNIVERSITY RESEARCH ANDBUSINESS FOUNDATION, Seoul (KR)

(21) Appl. No.: 18/449,241

(22) Filed: Aug. 14, 2023

(30) Foreign Application Priority Data
Sep. 23, 2022 (KR) 10-2022-0121066
Mar. 16, 2023 (KR) 10-2023-0034285

(51) Int. Cl. G06N 3/08; G06N 3/049

(52) U.S. Cl. CPC G06N 3/08; G06N 3/049

(57) ABSTRACT

Disclosed are a method of training a spiking neural network computation based on a temporal coding and a system thereof. The method includes a kernel generation operation of generating a kernel computation for a log computation, a conversion recognition learning operation of converting a spike timestep using the kernel computation and one or more activation functions, a PSP computation operation of computing a sum of postsynaptic potentials (PSPs) using the converted spike timestep, and an SNN learning operation, by a spiking neural network (SNN) model, of training data using a membrane potential value depending on the sum.

### CROSS-REFERENCE TO RELATED APPLICATIONS

This application claims priority under 35 U.S.C. § 119 to Korean Patent Application No. 10-2022-0121066 filed on Sep. 23, 2022 and Korean Patent Application No. 10-2023-0034285 filed on Mar. 16, 2023, in the Korean Intellectual Property Office, the disclosures of which are incorporated by reference herein in their entireties.

### BACKGROUND

Embodiments of the present disclosure described herein relate to a method and system for computing and training a spiking neural network based on a temporal coding.

A spiking neural network (SNN) has a characteristic similar to the human brain since neurons and synapses connecting neurons transfer information in spike-type electrical signals. The SNN processes information based on the time difference between transmission of spike signals. The SNN transfers information with a binary spike signal, and transfers the information in the form of a set of 0 or 1 binary spikes.

For example, when a spike arrives at an input of a neuron, the input spike is decoded and calculated with a synaptic weight, and the result is accumulated on the membrane potential of the neuron. When the accumulated membrane potential value has a value greater than or equal to a threshold value, the neuron generates an output spike, and the output spike is transferred to the next neuron. In this process, the membrane potential of the neuron that generates the spike is initialized to ‘0’.

As described above, since the computation of the SNN operates only when a spike occurs, low-power hardware may be implemented. However, when processing complex computations, conventional SNN computation has issues in that hardware burden is increased compared to general analog artificial neural network (ANN) computation.

### SUMMARY

Embodiments of the present disclosure provide a spiking neural network computation learning method based on a temporal coding capable of processing complex computations with low power, and a system thereof.

According to an embodiment of the present disclosure, a method of training a spiking neural network computation based on a temporal coding includes a kernel generation operation of generating a kernel computation for a log computation, a conversion recognition learning operation of converting a spike timestep using the kernel computation and one or more activation functions, a PSP computation operation of computing a sum of postsynaptic potentials (PSPs) using the converted spike timestep, and an SNN learning operation, by a spiking neural network (SNN) model, of training data using a membrane potential value depending on the sum.

According to an embodiment of the present disclosure, a spiking neural network computation learning system based on a temporal coding includes a kernel generator that generates a kernel computation for a log computation, a conversion recognition learning unit that converts a spike timestep using the kernel computation and one or more activation functions, a PSP computation unit that computes a sum of postsynaptic potentials (PSPs) using the converted spike timestep, and an SNN learning unit that trains, by a spiking neural network (SNN) model, data using a membrane potential value depending on the sum.

### BRIEF DESCRIPTION OF THE FIGURES

The above and other objects and features of the present disclosure will become apparent by describing in detail embodiments thereof with reference to the accompanying drawings.

FIG. 1 is a diagram schematically illustrating an SNN spiking coding technique.

FIG. 2 is a flowchart of a spiking neural network computation learning method based on a temporal coding, according to an embodiment of the present disclosure.

FIG. 3 is a flowchart of a PSP computation operation, according to an embodiment of the present disclosure.

FIG. 4 is a diagram illustrating a logical computation of a PSP computation operation, according to an embodiment of the present disclosure.

FIG. 5 is a block diagram of a spiking neural network computation learning system based on a temporal coding, according to an embodiment of the present disclosure.

FIG. 6 is a block diagram of a processing device to which a spiking neural network computation learning system based on a temporal coding according to an embodiment of the present disclosure is applied.

FIG. 7 is a graph comparing used area and used power for a PE array of a processing device.

### DETAILED DESCRIPTION

Hereinafter, embodiments of the present disclosure will be described with reference to the accompanying drawings in order to describe the technical idea of the present disclosure in detail to the extent that those skilled in the art can easily carry out it.

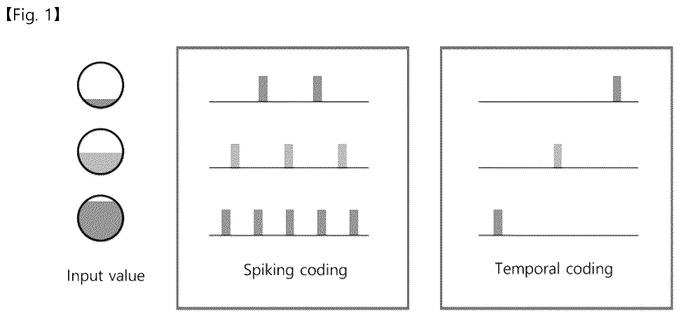

FIG. 1 is a diagram schematically illustrating an SNN spiking coding technique.

Spiking coding refers to a method of interpreting spikes.

FIG. 1 illustrates a general spiking coding technique and a temporal coding technique according to the present disclosure. A general spike coding technique is a coding technique that increases a spike rate in proportion to an input value. Continuing to refer to FIG. 1, the temporal coding technique according to the present disclosure is a coding technique in which spikes are input at a faster time as the input value is greater.

Since the general spiking coding technique performs a computation as many times as the spike rate, there is a problem that the computation increases compared to the temporal coding technique. In detail, since the temporal coding technique generates only one spike, it is possible to drive a low-power SNN with a small amount of computation.

However, to process complex data, the temporal coding technique performs a multiplication computation, and this multiplication computation imposes a burden on hardware. In detail, such a multiplication computation hinders low-power operation, which is an advantage of the SNN.

For example, the following equation is an accumulative value of postsynaptic potential, and is required to calculate a membrane potential value. The conventional membrane potential value is calculated by the following equation.

uⱼ^{l}(t)=uⱼ^{l}(t−1)+zⱼ^{l}(t)

Here, ‘t’ is a spike timestep.

The conventional accumulative value zⱼ^{l} of the postsynaptic potential includes complex multiplication computations as illustrated in the following equation.

$${z}_{j}^{l} ( t ) = {\sum }_{i} {w}_{ij}^{l} \times {ε}_{IN}^{l} ( {t}^{l - 1} - {t}_{ref}^{l - 1} ) + {b}_{j}^{l}$$

Here, l is the layer order, t^{l-1} is the spike timestep of the (l−1)-th layer, t^{l}_{ref} is a spice computation start time, w^{l}ᵢⱼ is a synaptic weight, εhu l_{IN} is an integral of the kernel, and b^{l}ⱼ is a dendrite function.

The multiplication computations are not commonly used in SNN learning models. Accordingly, the spiking neural network computation method based on a temporal coding according to an embodiment of the present disclosure converts the multiplication computation into an addition computation or a shift computation and applies it to the SNN.

Therefore, complex computations that could only be processed by the conventional ANN learning model may be processed with low power.

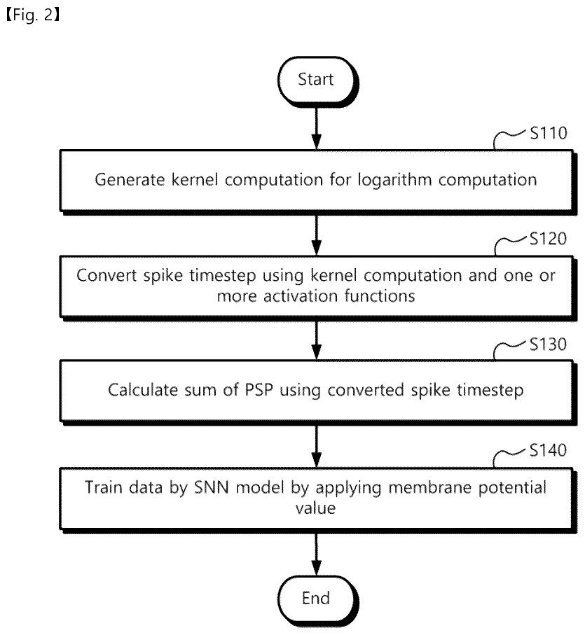

FIG. 2 is a flowchart of a spiking neural network computation learning method based on a temporal coding, according to an embodiment of the present disclosure.

Referring to FIG. 2, the spiking neural network computation learning method based on a temporal coding includes a kernel generation operation (S110), a conversion recognition learning operation (S120), a PSP computation operation (S130), and an SNN learning operation (S140).

In operation S110, a kernel generation operation may be performed. For example, a kernel for logarithm computation may be generated.

Kernel ε^{l} for conventional temporal coding is as follows.

ε^{l}(t−t_{ref}^{l})=exp(−(t−t_{ref}^{l}−t^{l}_{d})/τ^{l})

Here, ‘t’ is the spike timestep, τ^{l} is a time constant of layer l, t^{l}_{d} is the spike delay time, and t^{l}_{ref} is a computation start time of the spike.

The conventional kernel ε^{l} has a logarithmic base of ‘e’ and t^{l}_{d} and τ^{l} values have different values for each layer, so it is not suitable for application to learning and reasoning of the SNN model.

Therefore, the present disclosure generates a kernel computation for logarithm computation, and the generated kernel computation is as follows.

κ^{l}(t−t_{ref}^{l})=2^{-(t-t}^{_{ref}}^{^{l}}^{)/τ} [Equation 1]

Here, κ^{l} is the kernel of the layer, ‘τ’ is the time constant of the layer, and t^{l}_{ref} is the computation start time of the spike. In addition, since the value of ‘τ’ is the same in all layers and the log base is 2, it is suitable for training binary spikes used in SNN models.

In operation S120, a conversion recognition learning operation may be performed. For example, a conversion operation for a spike timestep may be performed using the kernel computation and one or more activation functions.

Here, conversion recognition learning is a technique devised because it is difficult to apply backpropagation learning, which is a learning method of high-performance analog ANN (Artificial Neural Network), to the SNN.

In operation S120, the activation function may include at least one or more of a ReLU function, a Clip function, and a Time to First Spike (TTFS) function, but is not limited thereto, and may be any function applicable to the SNN model.

The activation function is a function that serves to transfer a signal to a neuron in another layer by converting a result value of a previous layer, and the ReLU function and the Clip function are well-known activation functions, and may be expressed by the following equation.

$$ReLU ( x ) = \{ \begin{matrix}x , & 0 < x \\ 0 , & x \leq 0\end{matrix} \\ Clip ( x ) = \begin{matrix}\begin{matrix}max , & max < 0\end{matrix} \\ \{ \begin{matrix}x , & min < x < max \\ min , & otherwise\end{matrix}\end{matrix}$$

However, the TTFS (Time to First Spike) function is an optimal activation function developed to implement the present disclosure, and may be expressed by the following equation.

$$TTFS ( x ) = \begin{matrix}\begin{matrix}0 , & x < {κ}^{l} ( T - {t}_{ref}^{l} )\end{matrix} \\ \{ \begin{matrix}{2}^{[ {τ log}_{2} ( x / {θ}_{0} ) ]} & {κ}^{l} ( T - {t}_{ref}^{l} \leq x < {θ}_{0} ) \\ {θ}_{0} , & otherwise\end{matrix}\end{matrix} \qquad [ Equation 2 ]$$

Where, ‘T’ is a time window of the layer, ‘κ^{l}’ is a kernel of the layer, ‘τ’ is a time constant of the layer, t^{l}_{ref} is a computation start time of the spike, and θ₀ is a set threshold value. In detail, the time window ‘T’ of the layer denotes a time interval in which a spike computation may be performed in each layer, and the spike computation start time t^{l}_{ref} denotes a start time of the time window of each layer.

The computation of the converted spike timestep slightly increases the complexity of the inference hardware. To further reduce the complexity of such hardware, the TTFS function may be expressed as in Equation 2 to include a logarithmic computation.

In addition, the activation functions may be used to continuously convert the spike timestep in the order of the ReLU function, the Clip function, and the TTFS function, but is not limited thereto.

Then, the spike timestep is converted using the activation function and the kernel computation capable of the logarithmic computation. In this case, the converted spike timestep includes log information.

Specifically, the conventional spike timestep t^{l} is as follows.

t^{l}=[τ^{l}ln(uᵢ^{l}(t_{ref}^{l}−1)/θ₀)]+t_{ref}^{l}

Here, τ^{l} is the time constant of layer l, θ₀ is the set threshold value, and the base of the log is ‘e’.

In detail, when the spike timestep is converted using the kernel operation and the TTFS function, it is converted into the following equation.

t^{l}=[τlog₂(uᵢ^{l}(t_{ref}^{l}−1)/θ₀)]+t_{ref}^{l} [Equation 3]

Here, ‘τ’ is a time constant, uⱼ^{l} is the membrane potential value, t^{l}_{ref} is a computation start time of the spike, and θ₀ is a set threshold value. In this case, since the converted spike timestep has a base of the log of 2, it is suitable for training binary spikes used in the SNN models. In detail, when the log information of the converted spike timestep is used, complexity is reduced when computing the sum of the postsynaptic potentials.

In addition, compared to the conventional spike timestep, a different τ^{l} value for each layer may be converted into the same ‘τ’ value in all layers.

Therefore, complex computations that can only be processed by the ANN learning model may be processed by the SNN learning model with low power by the conversion recognition learning operation (S120).

In operation S130, a PSP computation operation may be performed. For example, the sum of postsynaptic potentials (PSPs) may be calculated using the converted spike timestep.

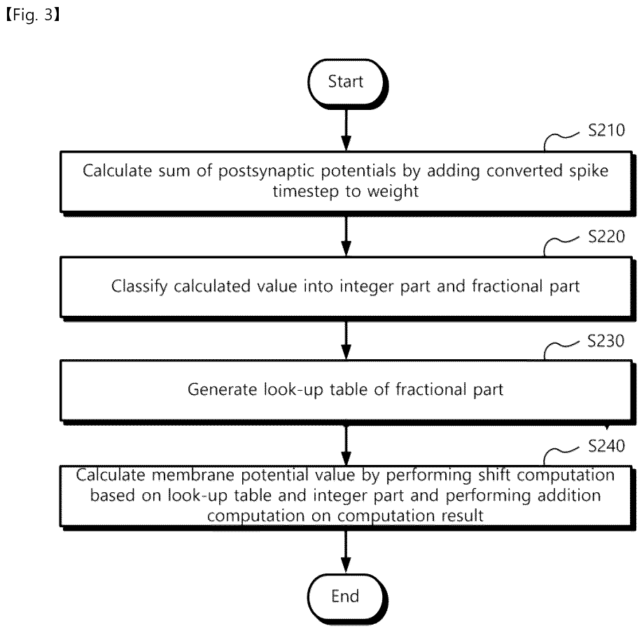

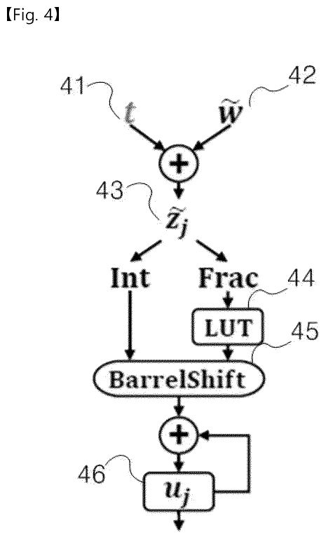

Operation S130 will be described in detail with reference to FIGS. 3 and 4.

FIG. 3 is a flowchart of the PSP computation operation (S130) according to an embodiment of the present disclosure, and FIG. 4 is a diagram illustrating a logical computation of the PSP computation operation (S130) according to an embodiment of the present disclosure.

In operation S210, an operation of calculating the PSP may be performed. For example, the sum of postsynaptic potentials zⱼ (43) may be calculated by adding the converted spike timestep ‘t’ (41) to the weight ‘w’ (42).

In operation S220, the calculated value may be classified into an integer part Int and a fractional part Frac.

In operation S230, a look-up table LUT (44) of the fractional part may be generated.

In operation S240, the membrane potential value uⱼ (46) may be calculated by performing a shift computation 45 based on the look-up table and the integer part and performing an addition computation on the computation result.

Here, the shift computation may be a computation method using the barrel shifter 45.

In operation S130, the complexity of the computation is reduced by converting the complex multiplication computations used in the conventional PSP computation process into the addition computation or the shift computation.

In detail, by converting a multiplication computation not used in the SNN learning model into the addition computation or the shift computation, the spiking neural network computation method based on a temporal coding, which is an embodiment of the present disclosure, is optimized for the SNN learning model.

In operation S140, the spiking neural network (SNN) model may be trained. For example, the SNN model may train data by applying the membrane potential value according to the sum.

Therefore, according to the above-described embodiment of the present disclosure, complex computations that can only be processed by the ANN learning model may be processed by the SNN learning model with low power.

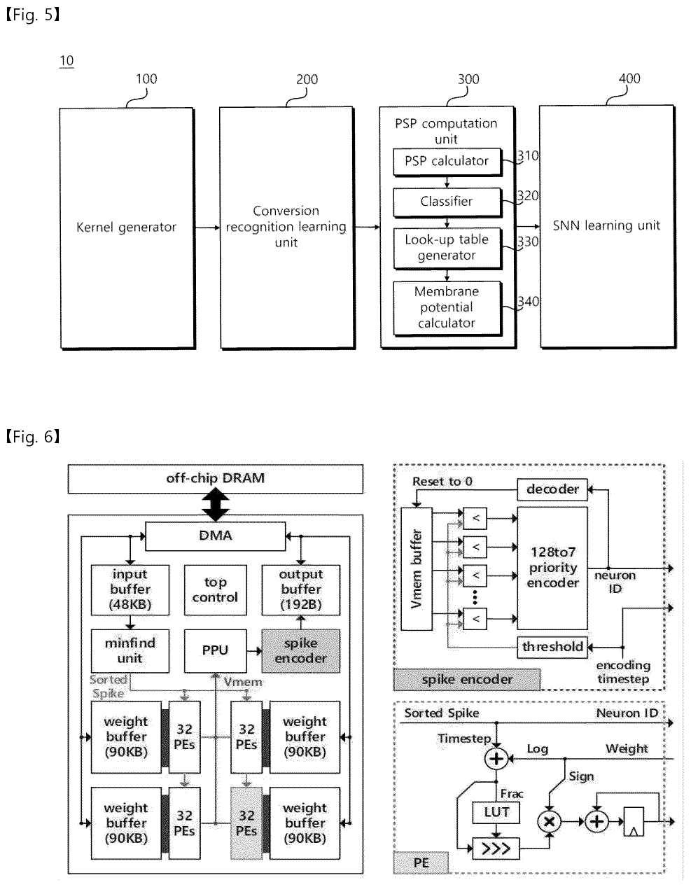

FIG. 5 is a block diagram of a spiking neural network computation learning system 10 based on a temporal coding, according to an embodiment of the present disclosure.

Referring to FIG. 5, the spiking neural network computation learning system 10 based on a temporal coding according to an embodiment of the present disclosure includes a kernel generator 100, a conversion recognition learning unit 200, a PSP computation unit 300, and an SNN learning unit 400.

The kernel generator 100 may generate a kernel computation for log computation.

The conventional kernel ε^{l} has a base of the log of ‘e’, and t^{l}_{d} and τₗ values have different values for each layer, so it is not suitable for application to the SNN model training.

Therefore, the present disclosure generates a kernel computation for log computation, and the generated kernel computation is the same as Equation 1 described above.

In Equation 1, since the value of ‘τ’ is the same in all layers and the base of the log is 2, it is suitable for training binary spikes used in the SNN model.

The conversion recognition learning unit 200 may convert the spike timestep using the kernel operation and one or more activation functions.

In the conversion recognition learning unit 200, the activation function may include at least one or more of a ReLU function, a Clip function, and a Time to First Spike (TTFS) function, but is not limited thereto, and may be any function applicable to the SNN model.

Here, the TTFS function is an optimal activation function developed to implement the present disclosure, and may be expressed as Equation 2 above.

The computation of the converted spike time slightly increases the complexity of the inference hardware. To further reduce the complexity of such hardware, the TTFS function may be expressed as in Equation 2 to include a logarithmic computation.

Then, the spike timestep is converted using the activation function and the kernel computation capable of the logarithmic computation. In this case, the converted spike timestep includes log information.

That is, when the spike timestep is converted using the kernel operation and the TTFS function, it is converted into Equation 3 below.

In this case, since the converted spike timestep has a base of the log of 2, it is suitable for training binary spikes used in the SNN models. In detail, when the log information of the converted spike timestep is used, complexity is reduced when computing the sum of the postsynaptic potentials.

Therefore, complex computations that may be processed only by the ANN learning model by the conversion recognition learning unit 200 can be processed by the SNN learning model with low power.

The PSP computation unit 300 may compute the sum of postsynaptic potentials (PSPs) using the converted spike timestep.

In addition, referring to FIG. 5, the PSP computation unit 300 may include a PSP calculator 310, a classifier 320, a look-up table generator 330, and a membrane potential calculator 340.

The PSP calculator 310 may calculate the sum of postsynaptic potentials by performing an addition computation on the converted spike timestep and the weight.

The classifier 320 may classify the calculated value into an integer part and a fractional part.

The look-up table generator 330 may generate a look-up table of the fractional part.

The membrane potential value calculator 340 may calculate the membrane potential value by performing a shift operation based on the look-up table and the integer part and performing an addition computation on the computation result.

The membrane potential value calculator 340 may further include a barrel shifter that performs the shift computation.

The PSP computation unit 300 reduces the complexity of the computation by converting the complex multiplication computation used in the conventional PSP computation process into the addition computation or the shift computation.

In detail, by converting multiplication computations not used in the SNN learning model into addition computations or shift computations, the spiking neural network computation learning system 10 based on a temporal coding, which is an embodiment of the present disclosure, is optimized for the SNN learning model.

The SNN learning unit 400 may train data by a spiking neural network (SNN) model by applying a membrane potential value to the sum of the postsynaptic potentials.

Therefore, according to the above-described embodiment of the present disclosure, complex computations that can only be processed by the ANN learning model may be processed by the SNN learning model with low power.

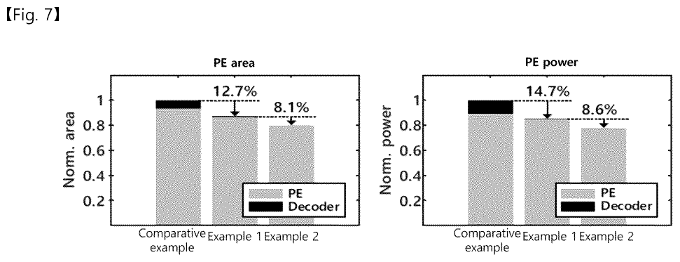

FIG. 6 is a block diagram of a processing device to which the spiking neural network computation learning system 10 based on a temporal coding according to an embodiment of the present disclosure is applied.

Referring to FIG. 6, the processing device to which the spiking neural network computation learning system 10 based on a temporal coding according to the present disclosure is applied may include four major components, that is, an input generator, a PE (Process Element) array, an output processing device, and an output control device.

The input generator includes an input buffer of 48 KB and minfind units, and merges input spikes. The PE array is composed of 128 PEs and four 90 KB weight buffers, and includes a spiking neural network computation learning system based on a temporal coding according to the present disclosure.

The output processing device is composed of a post-processing unit (PPU) and a spike encoder, processes the output of the PE array as a spike, stores the output spike in an output buffer, and then transmits spike information to a DRAM. In addition, the output control device controls the entire processing devices, and a DMA engine manages data access with respect to an off-chip DRAM.

The input spikes are processed in an aligned manner in the input generator, and the aligned spikes are supplied to the PE array and accumulated as a membrane potential. The output of the PE array is transferred to the output processing device and is encoded into output spikes (fire operation).

In this case, the spiking neural network computation learning system 10 based on a temporal coding according to the present disclosure may be applied to the PE array of the processing device.

Then, it is possible to drive hardware with low power while performing high-performance training that can only be processed by the existing ANN training model with the SNN training model.

FIG. 7 is a graph comparing used area and used power for a PE array of a processing device.

The comparative example is an example in which a conventional temporal coding-based PE array is applied. The conventional PE arrays use a static RAM (SRAM) to interpret spikes and use linear PE arrays to process decoded spikes.

Example 1 is a PE array to which the spiking neural network computation learning system 10 based on a temporal coding according to an embodiment of the present disclosure is applied. As described above, in Example 1, since the kernel parameters of all layers, that is, the values of t^{l}_{d} and τ^{l} are the same, the SRAM, which is a spike decoder, may be converted into a look-up table. That is, since the decoder is removed while generating the look-up table, the area occupied by the decoder in the PE array may be reduced.

Example 2 is a PE array to which the spiking neural network computation learning system 10 based on a temporal coding according to another embodiment of the present disclosure is applied. Example 2 is constructed using the TTFS function (Equation 2) as the activation function of the conversion recognition learning unit 200 in the PE array of Example 1.

The computation of the converted spike timestep slightly increases the complexity of the inference hardware. To further reduce the complexity of such hardware, the TTFS function is expressed as in Equation 2 to include a logarithmic computation.

When the TTFS function is used as the activation function, the linear PE array is converted into a PE array of a log domain.

Referring to FIG. 7, in Example 1, compared to comparative example, the area used for the PE array is reduced by 12.7%, and the power used for the PE array is reduced by 14.7%.

In Example 2, compared to comparative example, the used area of the PE array is reduced by 20.8%, and the power used in the PE array is reduced by 23.3%.

In this case, the accuracy of Example 1 and Example 2 compared to the comparative example is the same as each other.

Therefore, through experiments, it is confirmed that the spiking neural network computation learning system 10 based on a temporal coding according to the present disclosure maintains accuracy, and may be miniaturized and driven with low power.

According to an embodiment of the present disclosure, the spiking neural network computation learning method may process complex computations that could only be processed with an ANN learning model in the conventional art with low power consumption.

The above descriptions are specific embodiments for carrying out the present disclosure. Embodiments in which a design is changed simply or which are easily changed may be included in the present disclosure as well as an embodiment described above. In addition, technologies that are easily changed and implemented by using the above embodiments may be included in the present disclosure. While the present disclosure has been described with reference to embodiments thereof, it will be apparent to those of ordinary skill in the art that various changes and modifications may be made thereto without departing from the spirit and scope of the present disclosure as set forth in the following claims.

What is claimed is:

1. A method of training a spiking neural network computation based on a temporal coding, the method comprising:
a kernel generation operation of generating a kernel computation for a log computation;
a conversion recognition learning operation of converting a spike timestep using the kernel computation and one or more activation functions;
a PSP computation operation of computing a sum of postsynaptic potentials (PSPs) using the converted spike timestep; and
an SNN learning operation, by a spiking neural network (SNN) model, of training data using a membrane potential value depending on the sum.

2. The method of claim 1, wherein the PSP computation operation includes:
calculating the sum of the postsynaptic potentials by performing an addition computation on the converted spike timestep and a weight;
classifying the calculated sum value into an integer part and a fractional part;
generating a look-up table of the fractional part; and
calculating the membrane potential value by performing a shift computation based on the look-up table and the integer part and performing an addition computation on the computed result.

3. The method of claim 1, wherein the activation function includes a TTFS function as in the following equation,
$$TTFS ( x ) = \begin{matrix}\begin{matrix}0 , & x < {κ}^{l} ( T - {t}_{ref}^{l} )\end{matrix} \\ \{ \begin{matrix}{2}^{[ τ {log}_{2} ( x / {θ}_{0} ) ]} & {κ}^{l} ( T - {t}_{ref}^{l} \leq x < {θ}_{0} ) \\ {θ}_{0} , & otherwise\end{matrix}\end{matrix} \qquad [ Equation ]$$
where, ‘T’ is time window of a layer, ‘κ^{l}’ is a kernel of the layer, ‘τ’ is a time constant of the layer, t^{l}_{ref} is a computation start time of a spike, and θ₀ is a set threshold value.

4. The method of claim 1, wherein, in the kernel generation operation, the generated kernel is the following equation,
κ^{l}(t−t_{ref}^{l})=2^{-(t-t}^{_{ref}}^{^{l}}^{)/τ} [Equation]
, where ‘t’ is a spike timestep, ‘κ^{l}’ is a kernel of a layer, ‘τ’ is a time constant of the layer, and t^{l}_{ref} is a computation start time of a spike.

5. The method of claim 1, wherein, in the conversion recognition learning operation, the converted spike timestep is the following equation,
t^{l}=[τ log₂(uᵢ^{l}(t_{ref}^{l}−1)/θ₀)]+t_{ref}^{l} [Equation]
, where ‘τ’ is a time constant, uⱼ^{l} is the membrane potential value, t^{l}_{ref} is a computation start time of a spike, and θ₀ is a set threshold value.

6. A spiking neural network computation learning system based on a temporal coding comprising:
a kernel generator configured to generate a kernel computation for a log computation;
a conversion recognition learning unit configured to convert a spike timestep using the kernel computation and one or more activation functions;
a PSP computation unit configured to compute a sum of postsynaptic potentials (PSPs) using the converted spike timestep; and
an SNN learning unit configured to train, by a spiking neural network (SNN) model, data using a membrane potential value depending on the sum.

7. The spiking neural network computation learning system based on the temporal coding of claim 6, wherein the PSP computation unit includes:
a PSP calculator configured to calculate the sum of the postsynaptic potentials by performing an addition computation on the converted spike timestep and a weight;
a classifier configured to classify the calculated sum value into an integer part and a fractional part;
a look-up table generator configured to generate a look-up table of the fractional part; and
a membrane potential value calculator configured to calculate the membrane potential value by performing a shift computation based on the look-up table and the integer part and performing an addition computation on the computed result.

8. The spiking neural network computation learning system based on the temporal coding of claim 7, wherein the membrane potential value calculator further includes a barrel shifter configured to perform the shift computation.

9. The spiking neural network computation learning system based on the temporal coding of claim 6, wherein the activation function includes a TTFS function as in the following equation,
$$TTFS ( x ) = \begin{matrix}\begin{matrix}0 , & x < {κ}^{l} ( T - {t}_{ref}^{l} )\end{matrix} \\ \{ \begin{matrix}{2}^{[ τ {log}_{2} ( x / {θ}_{0} ) ]} & {κ}^{l} ( T - {t}_{ref}^{l} \leq x < {θ}_{0} ) \\ {θ}_{0} , & otherwise\end{matrix}\end{matrix} , \qquad [ Equation ]$$
where ‘T’ is time window of a layer, ‘κ^{l}’ is a kernel of the layer, ‘τ’ is a time constant of the layer, t^{l}_{ref} is a computation start time of a spike, and θ₀ is a set threshold value.
